(19) United States
(12) Patent Application Publication
(10) Pub. No.: US 2014/0061430 A1
(43) Pub. Date: Mar. 6, 2014

(54) APPARATUS FOR SENSING AN IMAGE SUN POSITION

(71) Applicant: Institute of Nuclear Energy Research, Atomic Energy Council, Executive Yuan, R.O.C., (US)

(72) Inventors: Hong-Yih Yeh, Taoyuan County (TW); Cheng-Dar Lee, Taoyuan County (TW)

(73) Assignee: Institute of Nuclear Energy Research, Atomic Energy Council, Exective Yuan, R.O.C., Taoyuan County (TW)

(21) Appl. No.: 13/889,476

(22) Filed: May 8, 2013

(30) Foreign Application Priority Data
Sep. 3, 2012 (TW) 101132092

(51) Int. Cl. G01S 3/786

(52) U.S. Cl. CPC G01S 3/7861
USPC 250/203.4

(57) ABSTRACT

An apparatus for sensing an image sun position is disclosed, comprising a casing, a light entrance hole on the casing and an optical unit within the casing and aligned with the optical unit; a tracking mechanism, connected to the image position sensing mechanism and comprises a holder, a solar battery module operatively connected to the holder, a first and second activation elements operatively connected to the solar battery module, respectively, and a control mechanism, connected to the optical unit and the first and second activation elements. This apparatus can directly acquire a sun image by using an image position sensing mechanism and activate a tracking mechanism to track and align with the determined sun position to enable the solar battery module to face straightly to sun, achieving low lost, high sensitivity and high tracking accuracy without using any encoder, illumination calculation and GPS (global positioning system).

### FIELD OF THE INVENTION

The present invention is related to an apparatus for sensing an image sun position, and particularly to an apparatus for sensing an image sun position, which can directly acquire a sun image by using an image position sensing mechanism and activate a tracking mechanism to track and align with the determined sun position, achieving low lost, high sensitivity and high tracking accuracy without using any encoder, illumination calculation and GPS (global positioning system).

### DESCRIPTION OF THE RELATED ART

A solar concentrator battery system has a higher electricity generating efficiency than a conventional one, but requires a high accuracy sun tracking system to achieve the high efficiency. How accurate the sun tracking system is has a direct effect upon the electricity generating efficiency. A sun position sensor is a key element for tracking the sun position in the sun tracking system, and thus a very issue is focused on improvement of the accuracy of the sun position sensor in the industry.

However, the currently available sun position sensor, e.g. the one disclosed in TW patent I300465, still has the four issues: viewing angle, light intensity, sensitivity, and cost, and will be explained in the following.

Viewing angle: If a sun position does not fall within the viewing angle of the sun position sensor, typically +/−45 to +/−75 degrees, the sun position cannot be detected and is determined as not presented and no further tracking is needed. Thus, this issue has to be well addressed.

Light intensity: within the viewing angle of the sun position sensor, the light intensity is used as a basis for determining if the tracking action should be performed. For example, when the light intensity of sun is too weak, no electricity generation is possible and thus the tracking action is saved for cost saving.

Sensitivity: it has a proportional relationship with a tracking accuracy, and is an essential issue for the sun position sensor.

Cost: since the cost issue has a direct effect on competitiveness of the solar energy electricity generating system, the key element of the sun position sensor plays the same role.

In a conventional sun position sensor, the characteristics of limited viewing angle, incapable recognition of light intensity, weak sensitivity and high cost are presented. And as a method for following sun is concerned, the former three characteristics issues are also encountered. For the currently available sun position sensor, although the three characteristics have been improved, the sensitivity issue still has to be overcome, forming a weak point in achieving a high accuracy of the sun position sensor since the light intensity of sun has been always the most important key for sensitivity.

In view of the drawbacks mentioned above, the inventor of the present invention provides an apparatus for sensing an image sun position, after many efforts and researches to make an improvement with respect to the prior art.

### SUMMARY OF THE INVENTION

It is, therefore, an object, of the present invention to provide an apparatus for sensing an image sun position, which can directly acquire a sun image by using an image position sensing mechanism, calculating the sun image and an illumination of the sun image and activate a tracking mechanism to track and align with the determined sun position, to enable a solar battery module to face straightly to sun, achieving low lost, high sensitivity and high tracking accuracy without using any encoder, illumination calculation and GPS (global positioning system).

The apparatus for sensing an image sun position according to the present invention comprises an image position sensing mechanism, comprising a casing having an altitude, a light entrance hole arranged on a facet of the casing and an optical unit arranged within the casing and aligned with the optical unit; a tracking mechanism, connected to the image position sensing mechanism and comprises a holder, a solar battery module operatively connected to the holder, a first activation element operatively connected to the solar battery module, and a second activation element operatively connected to the solar battery module, and a control mechanism, connected to the optical unit, the first activation element and the second activation element, respectively.

In an embodiment, the casing is made of aluminum alloy and has a lateral plate on each of circumferential portions thereof, respectively, and the lateral plate of the respective circumferential portions has an access hole thereon, respectively.

In an embodiment, the light entrance hole has a diameter having a ratio to the altitude of the casing of between 0 and 1.

In an embodiment, the optical unit includes a fixation ring, a rubber ring, a light reducing plate, a filtering plate, a telescope, an image sensing element, and a signal line arranged from bottom to top, wherein the signal line protruding from the casing at a portion thereof, and the portion of the casing has a water-proofing glue filled therewithin.

In an embodiment, the light reducing plate has a transmittance of between 1.5% and 0.1%.

In an embodiment, the filtering plate has a wavelength ranging between 400 nm to 700 nm and has a transmittance of larger than 90%.

In an embodiment, the image sensing element has a resolution and the telescope has a viewing angle, having a ratio to the resolution of the image sensing element of between 0 and 1.

In an embodiment, the first activation element is an azimuth motor.

In tan embodiment, the second activation element is an elevation motor.

In an embodiment, the control mechanism comprises a tracking mechanism connected to the optical unit and a motor driver connected to the first and second activation elements.

In an embodiment, the tracking controller comprises a full-color image acquiring unit connected to the optical unit, a color pattern conversion unit, an object recognition unit, an object boundary detecting unit, an article circle center benchmark unit, an article circle center calculating unit, an azimuth/elevation angle difference calculating unit and an output driving unit connected to the motor driver.

In an embodiment, the tracking controller receives a sun image generated from the optical unit, and the sun image is subsequently processed by the full-color image acquiring unit, the color pattern conversion unit, the object recognition unit, the object boundary detecting unit, the article circle center benchmark unit, the article circle center calculating unit, the azimuth/elevation angle difference calculating unit and the output driving unit, respectively, for a full-color image acquiring, a color pattern conversion, an object recognition, an object boundary detecting, an article circle center benchmark, an article circle center calculating, an azimuth angle difference and an elevation angle difference calculating actions, respectively, and then a motor driver is controlled based on the azimuth angle difference and elevation angle difference to enable the first and second activation elements to drive the solar battery module face straightly to sun.

In an embodiment, the full-color acquiring unit acquires a plurality of pixels each composed of R (red), G (green) and B (blue) colors.

In an embodiment, the color pattern conversion unit converses a color pattern from a RGB color pattern to an HSL color pattern.

In an embodiment, the object recognition unit separates an object and a background in an image, and selects an H, S and L threshold values to the object color, and set pixels within each of the H, S and L threshold values to be 1 and the other pixels to be 0.

In an embodiment, the object boundary detecting unit takes dots each having a significant variation as a boundary, and the significant variation includes a discontinuity in depth, a discontinuity in surface direction, substance attribute ad field scene illumination.

In an embodiment, the article circle center unit calculates a circle center (X, Y) by using a method of obtaining a circle by using three points.

In an embodiment, the azimuth/elevation difference calculating unit calculates difference with respect to a benchmark center Xc, Yc, and calculates an azimuth difference as X−Xc, and the image position sensing mechanism is directed to rotate eastward when the azimuth difference is positive, while westward when the azimuth difference is negative; and calculates an elevation difference Y−Yc, and the image position sensing mechanism is directed to rotate northward when the azimuth difference is positive, while southward when the azimuth difference is negative.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a schematic architecture diagram of the apparatus according to the present invention;

FIG. 2 is an exploded diagram of an image position mechanism of the apparatus according to the present invention; and

FIG. 3 is a schematic diagram of a control mechanism of the apparatus according to the present invention.

### DESCRIPTION OF THE PREFERRED EMBODIMENTS

The present invention is an apparatus for sensing an image sun position, which will be described in details as followings with annex drawings.

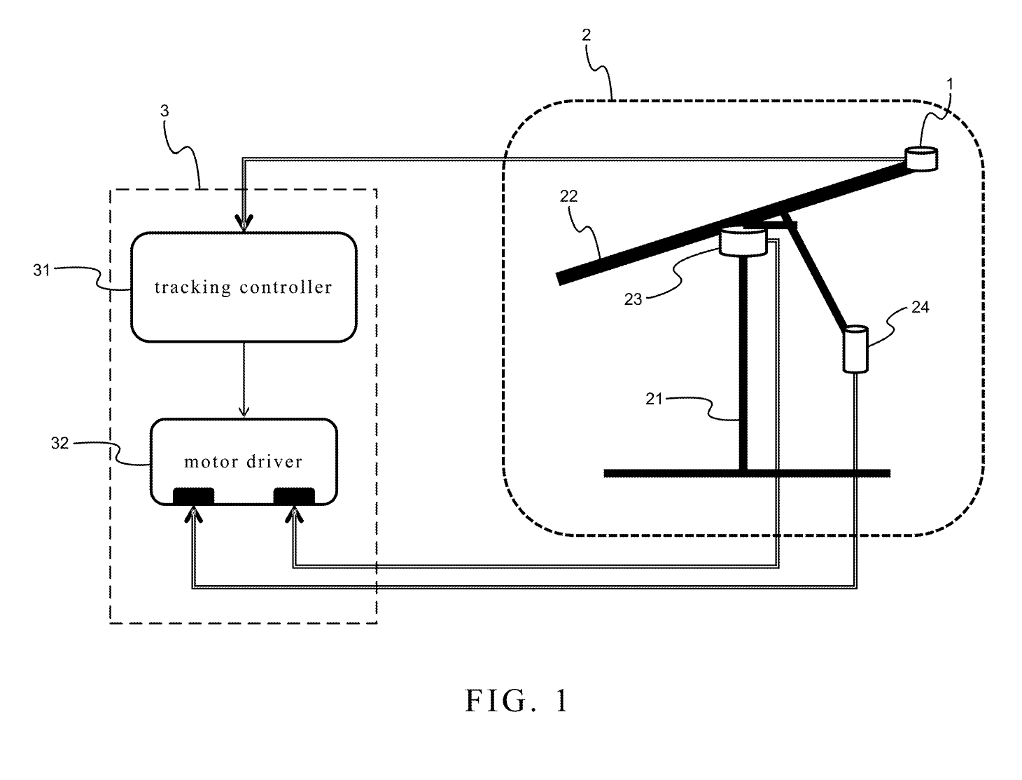

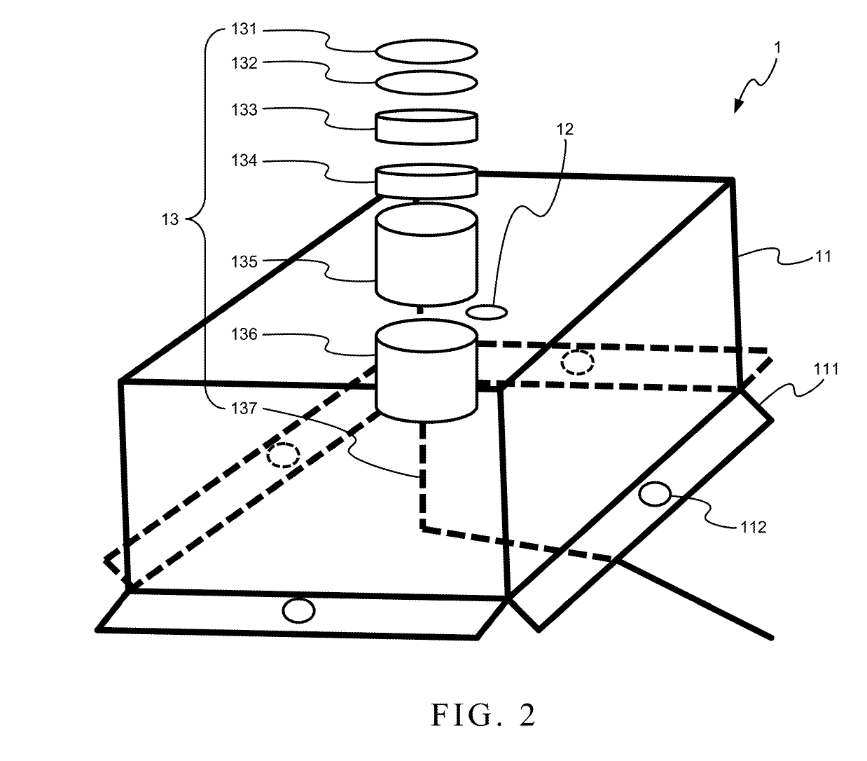

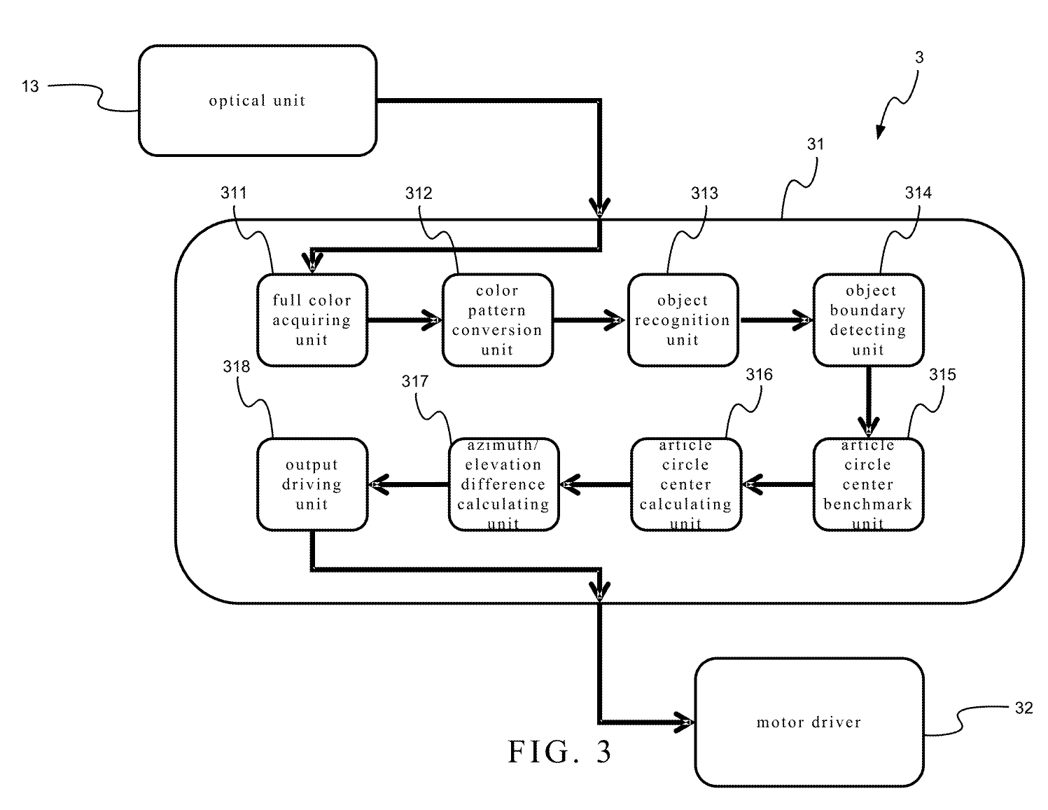

Referring to FIGS. 1, 2 and 3, a schematic architecture diagram of the apparatus according to the present invention, an exploded diagram of an image position mechanism of the apparatus according to the present invention, and a schematic diagram of a control mechanism of the apparatus according to the present invention, are shown, respectively.

As shown, the apparatus for sensing image sun position comprises an image position sensing mechanism 1, a tracking mechanism 2 and a control mechanism 3. The above mentioned image position sensing mechanism 1 comprises a casing 11, a light entrance hole 12 and an optical unit 13. The light entrance hole 12 is arranged on a facet of the casing 11. The optical unit 13 is arranged within the casing 11 and aligned with the optical unit 13. The light entrance hole 12 has a diameter, which has a ratio to an altitude of the casing 11 of between 0 and 1. The casing 11 is made of aluminum alloy and has some circumferential portions. A lateral plate 111 is arranged on each of the circumferential portions, respectively, and the lateral plate 111 on the respective circumferential portions has an access hole 112 thereon, respectively. The casing 1 may be installed on the tracking mechanism 2. The optical unit 13 includes a fixation ring 131, a rubber ring 132, a light reducing plate 133, a filtering plate 134, a telescope 135, an image sensing element 136, and a signal line 137 arranged from bottom to top. The signal line 137 protrudes from the casing 11 at a portion thereof, and the portion of the casing 11 has a water-proofing glue (now shown) filled therewithin. In this manner, the image position sensing mechanism 1 is formed as a water-proofing, humid-proofing and collision-proofing unit.

The light reducing plate 133 has a transmittance of between 1.5% and 0.1%. The filtering plate 134 has a wavelength ranging from 400 nm to 700 nm and has a transmittance of larger than 90%. The telescope 135 has a viewing angle. The image sensing element 136 has a resolution The viewing angle of the telescope 135 has a ratio to the resolution of the image sensing element 136 of between 0 and 1.

The tracking mechanism 2 is connected to the image position sensing mechanism 1 and comprises a holder 21, a solar battery module 22 operatively connected to the holder 21, a first activation element 23 operatively connected to the solar battery module 22, and a second activation element 24 operatively connected to the solar battery module 22. The first activation element is an azimuth motor 23 and the second activation element 24 is an elevation element.

The control mechanism 3 is connected to the optical unit 13, the first activation element 23 and the second activation element 24, respectively. The control mechanism 3 comprises a tracking mechanism 31 connected to the optical unit 13 and a motor driver 32 connected to the first and second activation elements 23, 24.

The tracking controller 31 comprises a full-color image acquiring unit 311 connected to the optical unit 13, a color pattern conversion unit 312, an object recognition unit 313, an object boundary detecting unit 314, an article circle center benchmark unit 315, an article circle center calculating unit 316, an azimuth/elevation angle difference calculating unit 317 and an output driving unit 318 connected to the motor driver 32.

In operation, the tracking controller 31 receives a sun image generated from the optical unit 13. The sum image from the tracking controller 31 is then directed to the full-color image acquiring unit 311, the color pattern conversion unit 312, the object recognition unit 313, the object boundary detecting unit 314, the article circle center benchmark unit 315, the article circle center calculating unit 316, the azimuth/elevation angle difference calculating unit 317 and the output driving unit 318 for the subsequent processings of full-color image acquiring, color pattern conversion, object recognition, object boundary detecting, article circle center benchmark, article circle center calculating, azimuth/elevation angle difference calculating, and the output driving, Based on the azimuth difference and elevation difference, the motor driver 31 is controlled to enable the first and second activation elements 23, 24 to face straightly sun.

In operation, the control mechanism 3 involves the following actions.

1. The full image acquiring unit 311: a signal acquired from digital image information is arranged as a matrix, with each of its units being called as a pixel. All the acquired images are in a format of RGB, i.e. red, green blue, color pattern.

2. Color pattern conversion unit 312: the RGB color pattern is conversed into an HSL, i.e. hue, saturation and lightness, color pattern.

Set r, g, and b to be a normalized coordinate value, a real number ranging from 0 to 1 of R, G and B, respectively. Further, max is set as a maximum one among r, g, and b, and min is set as the minimum one.

Formula (1) is used for conversion from the RGB pattern into an HSL color pattern:

$$H = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b ,\end{matrix} \\ L = \frac{1}{2} ( max + min ) , S = \{ \begin{matrix}0 & if L = 0 \\ \frac{max - min}{1 - \vert 2 L - 1 \vert} & otherwise\end{matrix}$$

where 0°≦H<360°; 0≦L≦1; 0≦S≦1.

3. The object recognition unit 313: an object is separated with its background. A threshold is respectively designated to H, S and L for the color of the object. All the pixels within each of the thresholds are each set to 1 (white), and the other pixels are each set to 0 (black).

When the full color image is subject to the object recognition action, it becomes a black-and-white image. In the black-and-white image, a sun image is recognized and sometimes some dots are presents therearound. To eliminate the dots, erosion and inflating process are used, while an area comparison method is used for larger dots.

4. The object boundary detecting unit 314: the sun image is subject to a boundary detecting action based on dots each having a significant variation in the image. It is the detections of (1) discontinuity in depth, (2) discontinuity in surface direction, (3) substance attribute and (4) field scene illumination.

5. The object circle center unit 316: a central position of the object may be calculated since the object has been separated with its background. Further, a method of obtaining a circle based on three points on the boundary is used to locate a circle center of the object. Now, the three points are set to have the coordinates: (x₁, y₁), (x₂, y₂), (x₃, y₃) respectively. The circle center is calculated by the following formula as:

$$\begin{matrix}( {x}_{1} - {x}_{2} ) x + ( {y}_{1} - {y}_{2} ) y + \frac{{x}_{2}^{2} - {x}_{1}^{2} + {y}_{2}^{2} - {y}_{1}^{2}}{2} = 0 , & ( 2 ) \\ ( {x}_{1} - {x}_{3} ) x + ( {y}_{1} - {y}_{3} ) y + \frac{{x}_{3}^{2} - {x}_{1}^{2} + {y}_{3}^{2} - {y}_{1}^{2}}{2} = 0. & ( 3 )\end{matrix}$$

Then, (2) and (3) are rewritten as:

$$\{ \begin{matrix}{a}_{1} x + {b}_{1} y + {c}_{1} = 0 \\ {a}_{2} x + {b}_{2} y + {c}_{2} = 0 ,\end{matrix} \\ wherein \\ \begin{matrix}{a}_{1} = {x}_{1} - {x}_{2} & & {a}_{2} = {x}_{1} - {x}_{3} \\ {b}_{1} = {y}_{1} - {y}_{2} & and & {b}_{2} = {y}_{1} - {y}_{3} \\ {c}_{1} = \frac{{x}_{2}^{2} - {x}_{1}^{2} + {y}_{2}^{2} - {y}_{1}^{2}}{2} & & {c}_{2} = \frac{{x}_{3}^{2} - {x}_{1}^{2} + {y}_{3}^{2} - {y}_{1}^{2}}{2} .\end{matrix}$$

Next, a substitution and elimination method is used to obtain the circle center (x, y):

$$\begin{matrix}x = \frac{{b}_{2} {c}_{1} - {b}_{1} {c}_{2}}{{a}_{2} {b}_{1} - {a}_{1} {b}_{2}} & y = \frac{{a}_{2} {c}_{1} - {a}_{1} {c}_{2}}{{a}_{1} {b}_{2} - {a}_{2} {b}_{1}} .\end{matrix} \qquad ( 4 ) .$$

6. The azimuth/elevation difference calculating unit 317: a tracking action is first performed in the east and west directions until it straightly faces sun and then in the south and north directions until it straightly faces sun.

This apparatus of the present invention can effectively improve the disadvantages encountered in the prior art, including a sun image may be required by using the image position sensing mechanism, the sun image and an intensity of the sun image may be required by the control mechanism and a tracking mechanism may be used to track and align to the determined sun position to enable the solar battery module to face sun, achieving low lost, high sensitivity and high tracking accuracy without using any encoder, illumination calculation and GPS (global positioning system).

Therefore, the present invention can be deemed as more practical, improved and necessary to users, compared with the prior art.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the appended claims.

What is claimed is:

1. An apparatus for sensing an image sun position,
comprising:
an image position sensing mechanism, comprising a casing having an altitude, a light entrance hole arranged on a facet of the casing and an optical unit arranged within the casing and aligned with the optical unit;
a tracking mechanism, connected to the image position sensing mechanism and comprises a holder, a solar battery module operatively connected to the holder, a first activation element operatively connected to the solar battery module, and a second activation element operatively connected to the solar battery module, and
a control mechanism, connected to the optical unit, the first activation element and the second activation element, respectively.

2. The apparatus according to claim 1, wherein the casing is made of aluminum alloy and has a lateral plate on each of circumferential portions thereof, respectively, and the lateral plate of the respective circumferential portions has an access hole thereon, respectively.

3. The apparatus according to claim 1, wherein the light entrance hole has a diameter having a ratio to the altitude of the casing of between 0 and 1.

4. The apparatus according to claim 1, wherein the optical unit includes a fixation ring, a rubber ring, a light reducing plate, a filtering plate, a telescope, an image sensing element, and a signal line arranged from bottom to top, wherein the signal line protruding from the casing at a portion thereof, and the portion of the casing has a water-proofing glue filled therewithin.

5. The apparatus according to claim 4, wherein the light reducing plate has a transmittance of between 1.5% and 0.1%.

6. The apparatus according to claim 4, wherein the filtering plate has a wavelength ranging between 400 nm to 700 nm and has a transmittance of larger than 90%.

7. The apparatus according to claim 4, wherein the image sensing element has a resolution and the telescope has a viewing angle, having a ratio to the resolution of the image sensing element of between 0 and 1.

8. The apparatus according to claim 1, wherein the first activation element is an azimuth motor.

9. The apparatus according to claim 1, wherein the second activation element is an elevation motor.

10. The apparatus according to claim 1, wherein the control mechanism comprises a tracking mechanism connected to the optical unit and a motor driver connected to the first and second activation elements.

11. The apparatus according to claim 10, wherein the tracking controller comprises a full-color image acquiring unit connected to the optical unit, a color pattern conversion unit, an object recognition unit, an object boundary detecting unit, an article circle center benchmark unit, an article circle center calculating unit, an azimuth/elevation angle difference calculating unit and an output driving unit connected to the motor driver.

12. The apparatus according to claim 11, wherein the tracking controller receives a sun image generated from the optical unit, and the sun image is subsequently processed by the full-color image acquiring unit, the color pattern conversion unit, the object recognition unit, the object boundary detecting unit, the article circle center benchmark unit, the article circle center calculating unit, the azimuth/elevation angle difference calculating unit and the output driving unit, respectively, for a full-color image acquiring, a color pattern conversion, an object recognition, an object boundary detecting, an article circle center benchmark, an article circle center calculating, an azimuth angle difference and an elevation angle difference calculating actions, respectively, and then a motor driver is controlled based on the azimuth angle difference and elevation angle difference to enable the first and second activation elements to drive the solar battery module face straightly to sun.

13. The apparatus according to claim 11, wherein the full-color acquiring unit acquires a plurality of pixels each composed of R (red), G (green) and B (blue) colors.

14. The apparatus according to claim 11, wherein the color pattern conversion unit converses a color pattern from a RGB color pattern to an HSL color pattern.

15. The apparatus according to claim 11, wherein the object recognition unit separates an object and a background in an image, and selects an H, S and L threshold values to the object color, and set pixels within each of the H, S and L threshold values to be 1 and the other pixels to be 0.

16. The apparatus according to claim 11, wherein the object boundary detecting unit takes dots each having a significant variation as a boundary, and the significant variation includes a discontinuity in depth, a discontinuity in surface direction, substance attribute ad field scene illumination.

17. The apparatus according to claim 11, wherein the article circle center unit calculates a circle center (X, Y) by using a method of obtaining a circle by using three points.

18. The apparatus according to claim 11, wherein the azimuth/elevation difference calculating unit calculates difference with respect to a benchmark center Xc, Yc, and calculates an azimuth difference as X−Xc, and the image position sensing mechanism is directed to rotate eastward when the azimuth difference is positive, while westward when the azimuth difference is negative; and calculates an elevation difference Y−Yc, and the image position sensing mechanism is directed to rotate northward when the azimuth difference is positive, while southward when the azimuth difference is negative.
